(19) United States
(12) Patent Application Publication
(10) Pub. No.: US 2002/0189579 A1
(43) Pub. Date: Dec. 19, 2002

(54) Emissions controller method and system

(76) Inventor: Richard H. Holtman, Dunlap, IL (US)

Correspondence Address: CATERPILLAR INC., 100 N.E. ADAMS STREET, PATENT DEPT., PEORIA, IL, 616296490

(21) Appl. No.: 09/882,690

(22) Filed: Jun. 15, 2001

(51) Int. Cl. F02B 19/00

(52) U.S. Cl. 123/261; 123/480

(57) ABSTRACT

The present invention provides a method and system to control emissions in an engine by controlling spray plume characteristics, such as length and angle. Specifically, a system implementing the present invention includes an fuel injector, an engine cylinder and an electronic control module (ECM). The ECM determines spray plume parameters, including time from start of injection, nozzle hole diameter, pressure differential between the cylinder and fuel in the fuel injector nozzle, and gas temperature and density in the cylinder. Upon determining the spray plume parameters, the ECM calculates the spray plume characteristics and compares them to the optimal spray plume characteristics. The ECM then proceeds to adjust fuel injection characteristics, such as injection on time, rail pressure, and injection timing relative to piston position, to optimize the spray plume.

### TECHNICAL FIELD

The present invention relates to a method and system for controlling smoke emissions in a engine and specifically controlling spray plume characteristics.

### BACKGROUND

Engine emissions control is very important in today's environmentally conscience society. Regulations have continually reduced the amount of allowable emissions, forcing engine manufacturers to find new ways of controlling the combustion process.

One area that has received considerable attention is the fuel injection process and its impact on combustion. A fuel injector injects pressurized fuel into the cylinder. In order to optimize the combustion process, it is desirable to atomize the fuel as much as possible, thereby reducing emissions. In order to properly atomize the fuel, it is necessary to expose the spray plume to as much area (combustion air) as possible; however control of plume size is necessary. If the spray plume is too large, such that the spray contacts the cylinder walls or piston, combustion is negatively affected and emissions are increased. Further, if the spray is too small, insufficient atomization can not occur, thereby preventing complete combustion and increasing emissions.

The prior art has attempted to control emissions related to fuel injection with timing, injector angles, swirl chambers, and other fixed designs. However, these approaches do not address the fact that the conditions affecting spray plume characteristics, such as length and angle, change with operating conditions. For example, the parameters that exist during cold start are noticeably different from the parameters that exist during hot running. The present invention is directed to overcoming one or more of the problems identified above.

### SUMMARY OF THE INVENTION

The present invention provides a method and system of reducing emissions from an engine. The method comprises determining spray plume parameters, calculating fuel injection spray plume characteristics, comparing the spray plume characteristics to predetermined spray plume characteristics and adjusting at least one fuel injection characteristic in response to the comparison in order to change the spray plume characteristics closer to the predetermined spray plume characteristics. The system includes a combustion chamber, a fuel injector, means to determine spray plume parameters, and an electronic control module to calculate and adjust spray plume characteristics.

### BRIEF DESCRIPTION OF THE DRAWINGS

FIG. 1 illustrates an exemplary engine system with which the present invention may be used.

FIG. 2 is a flow chart illustrating the method of controlling spray plume characteristics according to the present invention.

### DETAILED DESCRIPTION

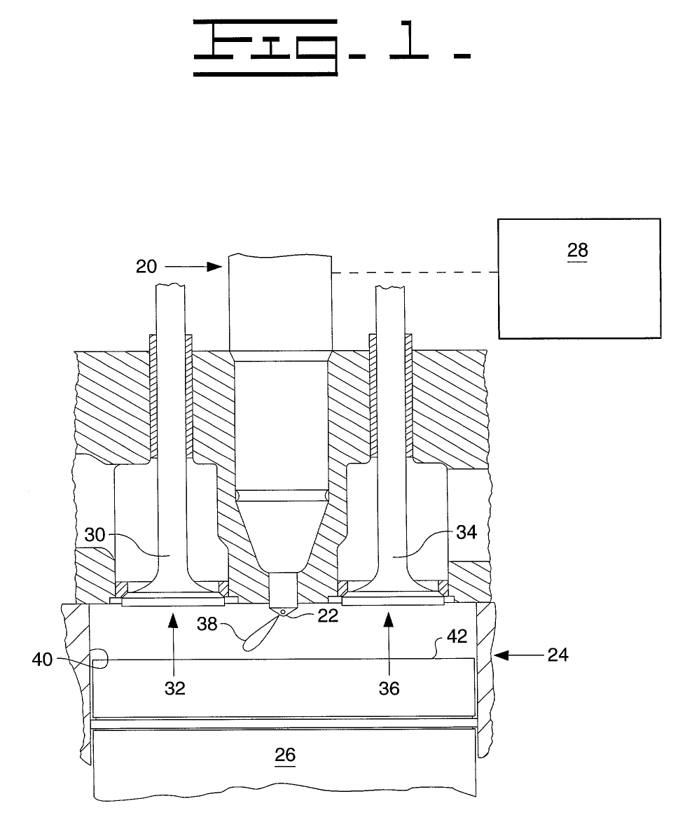

The present invention provides a method and system for controlling smoke emissions, specifically by controlling fuel injection spray plume characteristics, such as length and angle. FIG. 1 illustrates a general engine system, in which the present invention could be implemented, comprising a fuel injector 20, a cylinder 24, and an electronic control module (ECM) 28. The fuel injector 20 includes a nozzle 22 from which fuel, in the form of at least one spray plume 38, is injected into the cylinder 24 through at least one orifice (not shown). It is desirable that the spray plume 38 be an optimal size, allowing maximum atomization, without coming in contact with the cylinder wall 40 or piston head 26. It should be noted that the present invention could apply to a variety of fuel injection systems, including common rail, electronic unit injectors, and hydraulically actuated electronically controlled unit injectors.

The cylinder includes at least one intake port 32 and at least one exhaust port 36, which are selectively opened and closed by corresponding intake valve 30 and exhaust valve 34. Piston 26 is located within the combustion chamber or cylinder 24 to compresses air for combustion. The ECM 28 can monitor various system parameters, such as rail pressure (in a low or high pressure system), component and fluid temperatures (such as gas temperature in the combustion chamber), etc and subsequently control various aspects of the fuel injection and combustion process, such as injection timing, injection duration, valve opening/closing, rail pressure etc. It should be noted that FIG. 1 only shows the ECM 28 “connected” to the injector but the ECM 28 is actually electronically connected to numerous systems and components. For example, the ECM 28 could be connected to sensors in the cylinder or common rail for determining various parameters. The numerous types of “connections” necessary for monitoring and control of an engine and fuel injection are well known in the art and need not be explained in detail here.

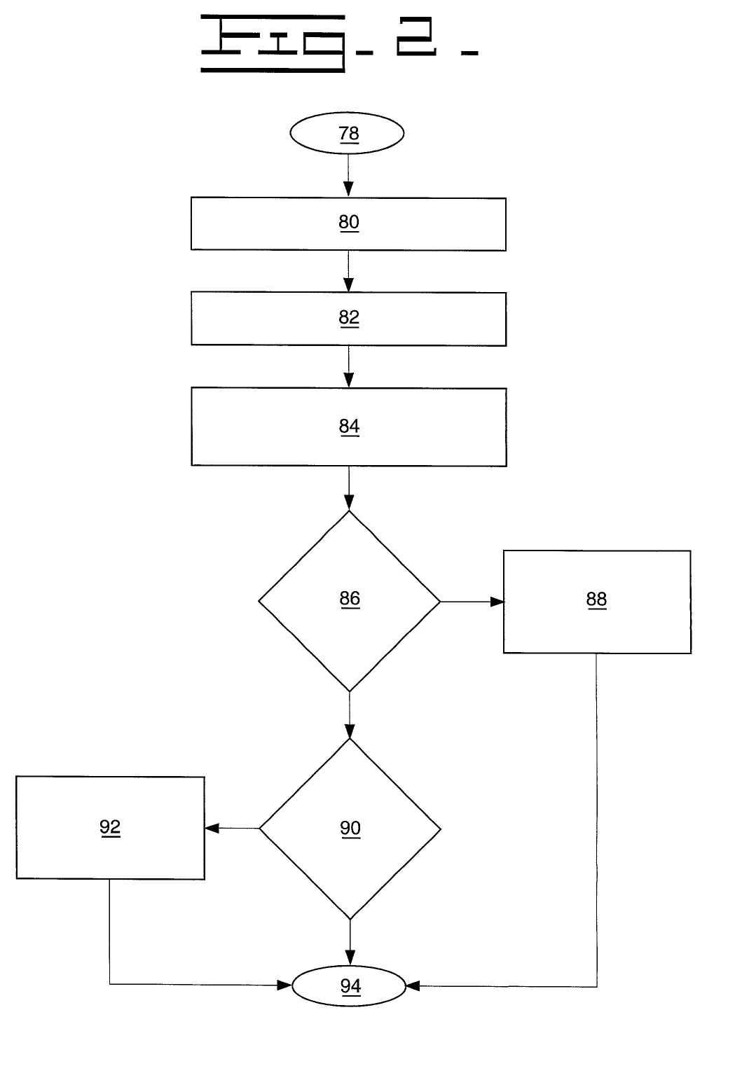

The present invention relates to controlling spray plume characteristics. FIG. 2 illustrates a flow chart for the present invention. The Flowchart begins at 78. At 80, the ECM 28 must determine several spray plume parameters. These include injection time, nozzle hole diameter, the pressure differential between the cylinder and the fuel in the nozzle, the gas density in the cylinder, the temperature of the fuel, and liquid density of the fuel. The means to determine the above parameters are well known in the art but could include appropriate sensors directly monitoring the described parameters or measuring related parameters and then inferring the other necessary parameters. Further, some of the above parameters, such as nozzle hole diameter, are constants and can be programmed in to the ECM at the time of production.

Next, at 82, the spray plume characteristics are determined. For example, the spray plume length can be calculated using the spray penetration equation:

s=3.07(Δp/ρg)^{¼}(tdₙ)^{½}(294/Tg)^{¼}

where

t=time from start of injection in seconds (injection duration)

s=plume length in meters

dₙ=nozzle hole diameter in meters

Δp=pressure differential between the combustion chamber and fuel in the fuel injector nozzle in pascals

ρ_{g}=gas density in the combustion chamber in kilograms per cubic meter

T_{g}=gas temperature in the combustion chamber in Kelvins.

The spray plume angle can be calculated using the spray plume angle equation:

tan Θ/2=(1/A)4Π(ρg/ρl)^{½}((√3)/6)

where

Θ=the angle of the spray plume

A=3.0+0.28(Lₙ/Dₙ)

where

Lₙ=length of the orifice in the nozzle in meters

Dₙ=diameter of the orifice in the nozzle in meters

ρ_{g}=gas density in the combustion chamber in kilograms per cubic meter

ρₗ=liquid density of the fuel in kilograms per cubic meter

(It should be noted that the above equations are not meant to be the only equations that can be used; other equations and variations of the above equations may also provide the relevant spray plume characteristics. For example, depending the type of system, the above equations may need to be modified to account for swirl in the combustion chamber.)

At 84, the ECM 28 then compares the spray plume characteristics with the optimal spray plume characteristics. For example, the optimal spray plume length for given operating conditions can be a predetermined distance, developed during injector/cylinder design or can be varied by ECM 28, based upon measured parameters and the type of injection. It should be noted that depending upon desired objectives, the ECM 28 could also compare the spray plume length to distances between the nozzle 22 and the cylinder wall 40 or the nozzle 22 and the piston head 42. These additional comparisons normally would not be necessary because the optimal spray plume length should take these distances in to account; however, the present invention has the ability to control spray plume length in a variety of manners. One could choose to not have an optimal spray plume length and just control the spray plume so that it does not contact any surfaces, such as the cylinder wall 40 or piston head 42. Further comparisons can also be performed in a similar manner, such as comparing the calculated spray plume angle to a predetermined angle.

At 86, the ECM 28 begins to optimize the spray plume characteristics. First, the ECM determines if the spray plume characteristics are greater than optimal. If so, the appropriate fuel injection characteristics are adjusted at 88 to reduce the spray plume characteristics. For example, if the spray plume length was too long, the ECM could modify injection duration, rail pressure, or timing of injection relative to piston position to reduce the length. If the spray plume characteristics are not greater than optimal, then the method proceeds to step 90 to determine if the spray plume characteristics are less than optimal. If so, step 92 adjusts the appropriate fuel characteristics to increase spray plume characteristics. If the spray plume characteristics are not less than optimal then the spray plume characteristics are optimal and no adjustments need to be made and the flowchart ends at 94.

Industrial Applicability

By controlling spray plume characteristics, smoke emissions are better controlled. This results from several factors. First, an optimal spray plume helps the fuel atomize as much as possible, which insures a more complete burning of the injected fuel. Second, control of the spray plume prevents fuel from coming in to contract with the cylinder wall or piston head, thereby avoiding unnecessary emissions. Generally, when fuel is sprayed on to the cylinder wall or piston head additional smoke is created during combustion, increasing emissions.

The present invention also provides a substantial improvement over the prior art by providing a method and system capable of controlling spray plume characteristics not only on the test bench in order to optimize design, but also in actual operation. The present invention allows the spray plume characteristics to be controlled during operation, as governing parameters change. For example, during cold start the temperature is low and the density of the gas in the cylinder is high; however, after the engine has been running for an extended period of time, the temperature will increase and the density will decrease. The ECM 28 can monitor these conditions and make necessary changes to optimize the spray plume characteristics and reduce emissions, such as limit injection duration or decrease rail pressure. Then as the temperature and density increase the ECM can respond accordingly and change the fuel injection characteristics as needed to maintain optimal operation.

The above description is intended for illustrative purposes only, and is not intended to limit the scope of the present invention in any way. Thus, those skilled in the art will appreciate that various modifications can be made to the illustrated embodiment without departing from the spirit and scope of the present invention. Other aspects, features, and advantages of the present invention may be obtained from a study of this disclosure and the drawings, along with the appended claims.

What is claimed is:

1. A method of reducing emissions from an engine comprising:
determining spray plume parameters;
calculating fuel injection spray plume characteristics using said spray plume parameters;
comparing said spray plume characteristics to predetermined spray plume characteristics; and
adjusting at least one fuel injection characteristic in response to said comparison to change said spray plume characteristics closer to said predetermined spray plume characteristics in response to said comparing step.

2. The method of claim 1 wherein said spray plume characteristics includes spray plume length.

3. The method of claim 2 wherein calculating said spray plume length includes using a spray penetration equation
s=3.07(Δp/ρ_{g})^{¼}(tdₙ)^{½}(294/T_{g})^{¼}
where
t=time from start of injection in seconds (injection duration)
s=plume length in meters
dₙ=nozzle hole diameter in meters
Δp=pressure differential between a combustion chamber and fuel in said fuel injector nozzle in pascals
ρ_{g}=gas density in said combustion chamber in kilograms per cubic meter
T_{g}=gas temperature in said combustion chamber in Kelvins.

4. The method of claim 1 wherein said spray plume characteristics includes spray plume angle.

5. The method of claim 1 wherein the step of adjusting said at least one fuel injection characteristic comprises decreasing at least one of said spray plume characteristics if said spray plume characteristics were larger than said predetermined spray plume characteristics.

6. The method of claim 5 wherein the step of adjusting said at least one fuel injection characteristics further comprises decreasing spray plume length if said plume length is longer than a predetermined spray plume length.

7. The method of claim 1 wherein the step of adjusting said at least one fuel injection characteristic comprises increasing at least one of said spray plume characteristics if said spray plume characteristics were larger than said predetermined spray plume characteristics.

8. The method of claim 7 wherein the step of adjusting said at least one fuel injection characteristics further comprises increasing spray plume length if said plume length is longer than a predetermined spray plume length.

9. The method of claim 1 wherein said fuel injection characteristics includes injection duration.

10. The method of claim 1 wherein said fuel injection characteristics includes rail pressure.

11. The method of claim 1 wherein said fuel injection characteristics includes injection timing based upon piston position.

12. The method of claim 1 wherein said spray plume parameters comprise those parameters defined by a spray penetration equation.

13. The method of claim 12 wherein said parameters defined by said spray penetration equation include time from start of injection, said spray plume length, nozzle hole diameter, pressure differential between a combustion chamber and fuel in an injector nozzle, gas density in said combustion chamber, and gas temperature in said combustion chamber.

14. The method of claim 1 wherein said spray plume parameters comprise those parameters defined by a spray plume angle equation.

15. The method of claim 14 wherein said parameters defined by said spray plume angle equation include gas density, liquid density of a fuel, length of a nozzle, and diameter of said nozzle.

16. The method of claim 1 wherein said predetermined spray plume characteristics includes a predetermined spray plume length.

17. The method of claim 16 wherein said predetermined spray plume length is equal to a maximum spray plume length such that said maximum spray plume length is as long as possible without coming in to contact with a combustion chamber (cylinder) wall or piston head.

18. A system to reduce smoke emissions in an engine comprising:
a combustion chamber,
a fuel injector,
means to determine spray plume parameters, and
an electronic control module (ECM) for calculating and adjusting spray plume characteristics.

19. The system of claim 18 wherein said means to determine said spray plume parameters includes sensors.

20. The system of claim 18 wherein said spray plume characteristics includes spray plume length.

21. The system of claim 18 wherein said spray plume characteristics includes spray plume angle.

22. The system of claim 18 wherein said ECM compares said spray plume characteristics with predetermined spray plume characteristics.

23. The system of claim 18 wherein said ECM adjusts, as needed, fuel injection characteristics, including injection duration, rail pressure, and injection timing relative to piston position to adjust said spray plume characteristics.

24. A method of reducing emissions from an engine during cold start comprising:
measuring an engine parameter to determine cold start conditions;
determining spray plume parameters;
calculating fuel injection spray plume characteristics using said spray plume parameters;
comparing said spray plume characteristics to predetermined spray plume characteristics; and
adjusting at least one fuel injection characteristic in response to said comparison to change said spray plume characteristics closer to said predetermined spray plume characteristics in response to said comparing step.

25. The method of claim 24 wherein said engine parameter includes ambient temperature, oil temperature, inlet air temperature, inlet manifold temperature and oil viscosity.

26. The method of claim 24 wherein said spray plume characteristics includes spray plume length.

27. The method of claim 24 wherein said spray plume characteristics includes spray plume angle.

28. The method of claim 24 wherein the step of adjusting said at least one fuel injection characteristic comprises decreasing at least one of said spray plume characteristics if said spray plume characteristics were larger than said predetermined spray plume characteristics.

29. The method of claim 24 wherein the step of adjusting said at least one fuel injection characteristic comprises increasing at least one of said spray plume characteristics if said spray plume characteristics were larger than said predetermined spray plume characteristics.
